(19) United States
(12) Patent Application Publication
(10) Pub. No.: US 2010/0249952 A1
(43) Pub. Date: Sep. 30, 2010

(54) Direct Control of Devices Through a Programmable Controller Using Internet Protocol

(75) Inventor: Todd A. Snide, Pelham, NH (US)

Correspondence Address: SCHNEIDER ELECTRIC / SQUARE D COMPANY;LEGAL DEPT. - I.P. GROUP (B&W), 1415 S. ROSELLE ROAD, PALATINE, IL, 60067, US

(73) Assignee: Schneider Electric/Square D Company, Palatine, IL (US)

(21) Appl. No.: 12/415,674

(22) Filed: Mar. 31, 2009

(51) Int. Cl. G05B 19/414

(52) U.S. Cl. 700/9

(57) ABSTRACT

Aspects of the invention support direct communication between a low-level device and a programmable controller over an automation bus in an industrial automation system for controlling and monitoring an industrial process. A leaf node device may include a low-level device. The leaf node device communicates directly with the programmable controller at the network layer, e.g., Internet Protocol (IP) based on an IP address contained in a signal so that the programmable controller may control the low-level device or receive status information about the low-level device. The industrial automation system may support a plurality of leaf node devices, which may be associated with different automation buses having different communication media. Signals between the programmable controller and the leaf node device may be directed with or without a switching element.

### BACKGROUND

A programmable logic controller (PLC) or programmable controller, which is typically a digital computer, is often used for automation of industrial processes, e.g., control of machinery on factory assembly lines, control of chemical processes, control of amusement rides, and control of lighting fixtures. PLCs are used in many different industries and machines such as packaging and semiconductor machines. Unlike general-purpose computers, a PLC is designed for multiple inputs and output arrangements, extended temperature ranges, immunity to electrical noise, and resistance to vibration and impact. Programs to control machine operation are typically stored in battery-backed or non-volatile memory. A PLC is an example of a real time system because output results are produced in response to input conditions within a bounded time; otherwise, unintended operation may result.

The main difference from other computers is that PLCs are typically armored for severe conditions (dust, moisture, heat, cold, and other environmental factors) and have the capability for extensive input/output (I/O) arrangements. In an industrial automation system, a PLC typically connects to sensors and actuators in order to read limit switches, analog process variables (e.g., temperature and pressure), and the positions of positioning systems, where the sensors and actuator devices may be simple peripheral (“dumb”) devices that have few operating states (e.g., on/off), and are unconditionally controlled by the PLC.

Traditional industrial automation systems typically control the simple peripheral devices (e.g., push-buttons, pilot lights, relays) indirectly by the PLC through an intermediary device. Consequently, the PLC does not directly communicate with the peripheral device. Rather, the intermediary device communicates with the PLC and passes the action required by the PLC to the peripheral device. Eliminating the need for the intermediary device, while effectively communicating and controlling peripheral devices, may be advantageous in an industrial automation system.

In a traditional automation system, the PLC typically controls and masters all functions and operations performed within the automation system. A pilot-light may be turned on or off as determined by the input of a push-button, but there is no direct connection between the pilot-light and the push-button. The PLC reads the input of the push-button. Based on the state of that input, the PLC subsequently writes to the pilot-light to place the pilot-light into the desired state (in this case either on or off) through an intermediary device. Any association of simple peripheral devices and the intermediary devices is done by the PLC. There is no direct wiring between the simple peripheral devices. The simple peripheral devices are connected to the intermediary device, which in turn, is connected to the PLC. The PLC sends a message to the intermediary device to control all of that intermediary device's simple peripheral devices. The message may contain a word destined for a specific memory location in the intermediary device's memory. The word is typically broken down into bits with each bit corresponding to a state for each of the simple peripheral devices connected to the intermediary device. Consequently, there are often situations in a traditional automation system in which the desired operation between the PLC and the simple peripheral devices may be corrupted or for the operator to make a mistake.

### SUMMARY

An aspect of the invention provides apparatuses, computer-readable media, and methods for supporting direct communication between a low-level device and a programmable controller over an automation bus in an industrial automation system for controlling and monitoring an industrial process.

With another aspect of the invention, a leaf node device includes a low-level device. The leaf node device communicates directly with the programmable controller at the network layer, e.g., Internet Protocol (IP).

With another aspect of the invention, a leaf node device directly receives a data packet over the automation bus from the programmable controller. The leaf node device extracts control information from the data packet in order to control a low-level device.

With another aspect of the invention, a leaf node device obtains status information from a low-level device, inserts the status information into a data packet, and directly transmits the data packet to the programmable controller.

With another aspect of the invention, an industrial automation system supports a plurality of leaf node devices, which may be associated with different automation buses having different communication media.

With another aspect of the invention, a signal over an automation bus is designated for different leaf node devices based on an IP address that is contained in the signal. Signals may be directed without a switching element, where each leaf node device recognizes its assigned IP address. With another aspect of the invention, signals are directed by a switching element, e.g., an IP switching element or an Ethernet switching element.

With another aspect of the invention, an industrial automation system includes a bridge node that is electrically connected between a programmable controller and a leaf node device. The bridge transforms a signal between the programmable controller and leaf node device at a physical layer. Consequently, direct communication between the programmable controller and the leaf node device is maintained at a network layer.

### BRIEF DESCRIPTION OF THE DRAWINGS

A more complete understanding of the present invention and the advantages thereof may be acquired by referring to the following description in consideration of the accompanying drawings, in which like reference numbers indicate like features and wherein:

FIG. 1 shows an automation network according to prior art.

FIG. 2 shows an industrial automation system in accordance with an embodiment of the invention.

FIG. 3 shows protocol layering for IP-based communication between a programmable controller and a low level device in accordance with an embodiment of the invention.

FIG. 4 shows a leaf node device in accordance with an embodiment of the invention.

FIG. 5 shows an industrial automation system with an IP switching element in accordance with an embodiment of the invention.

FIG. 6 shows another industrial automation system in accordance with an embodiment of the invention.

FIG. 7 shows an industrial automation system that supports media independent communication between a programmable controller and low level devices in accordance with an embodiment of the invention.

FIG. 8 shows an industrial automation system with a bridge node in accordance with an embodiment of the invention.

FIG. 9 shows a process in which a programmable controller controls a low-level device in accordance with an embodiment of the invention.

### DETAILED DESCRIPTION

In the following description of the various embodiments, reference is made to the accompanying drawings which form a part hereof, and in which is shown by way of illustration various embodiments in which the invention may be practiced. It is to be understood that other embodiments may be utilized and structural and functional modifications may be made without departing from the scope of the present invention.

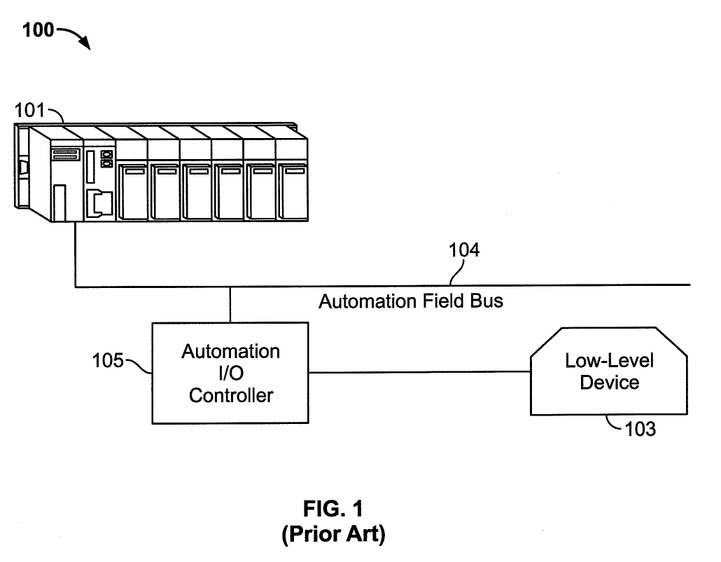

FIG. 1 shows automation network 100 according to prior art. When low-level device 103 has IP capabilities and can act as an IP leaf node device, the architecture of the automation network typically changes. A low-level device may encompass different categories of devices. For example, a low-level device may be referenced as a “dumb device” and/or can be unconditionally driven from a controlling device. A low-level device may also be a write-only device that can only be driven and cannot respond at all. A low-level device may also be a simple I/O device that can respond or be written to but does not make any other decisions. As another example, a low-level device may be restricted only to two states, e.g., a relay turning on or off or a pilot light emitting or not emitting light.

Automation network 100 includes programmable logic controller (PLC) 101 that performs as the controlling entity with an automation device (e.g., automation input/output (I/O) controller 105). Automation I/O controller 105 is connected to PLC 101 and to low-level devices (e.g., low-level device 103) via automation field bus 104. Input/output controller 105 is situated between PLC 101 and low-level device 103, in which communication from PLC 101 and low-level device 103 is through automation I/O controller 105. Automation I/O controller 105 typically contains command and control information for low-level device 103. If low-level device 103 has communications capabilities, then input/output controller 105 translates the information between PLC 101 and low-level device 103 because low-level device 103 typically does not use the same communication protocol as PLC 101.

Automation I/O controller (intermediary device) 105 communicates with PLC 101 and passes the action required by PLC 101 to low-level device 103. Intermediary device 105 may perform protocol translation in order to affect or detect a change in the state of the low-level device. Intermediary device 105 may be hardwired to low-level devices.

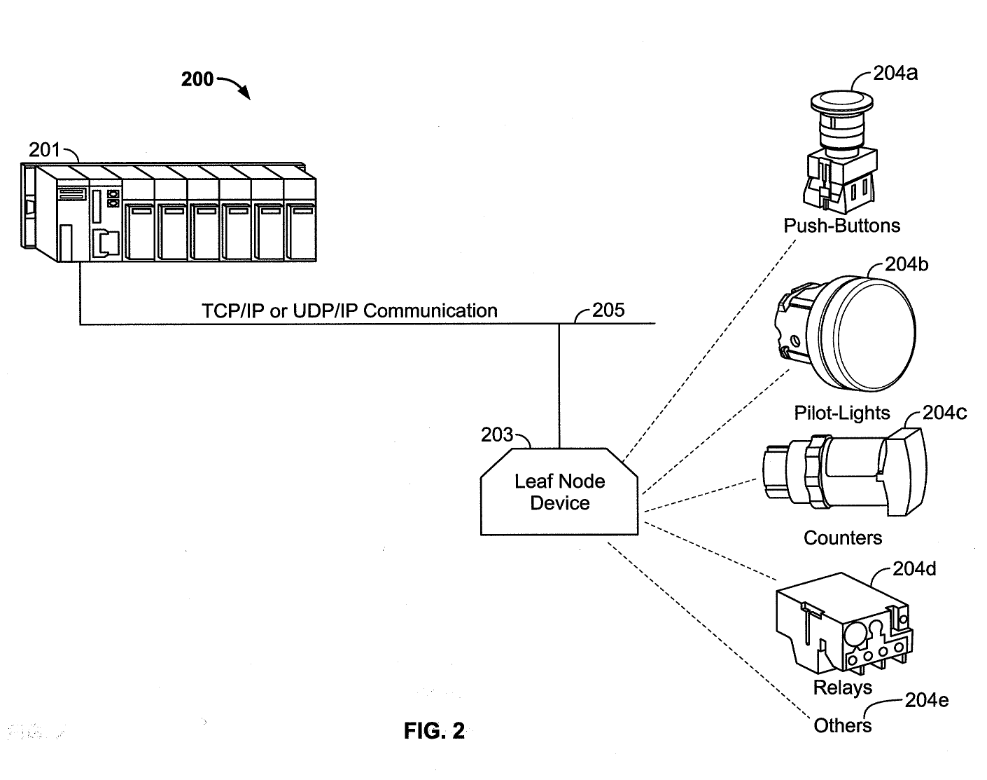

FIG. 2 shows industrial automation system 200 in accordance with an embodiment of the invention. With traditional automation networks, a programmable logic controller typically does not directly control low-level devices, e.g., push-buttons, pilot lights, sensors, indicators, and relays) but requires an intermediary device. The intermediary device communicates with programmable controller 201 and passes the action required by the programmable controller 201 to the low-level device 204a-e. (Programmable controller 201 may include a programmable logic controller or a programmable automation controller.) Often the intermediary device is required to perform a protocol translation to be able to affect or detect a change in the state of the low-level device. In many instances, the intermediary device is hardwired to the low-level devices. While FIG. 2 shows only low-level devices, embodiments of the invention can support systems with “high-level” devices and with a combination of “low-level” devices and “high-level” devices.”

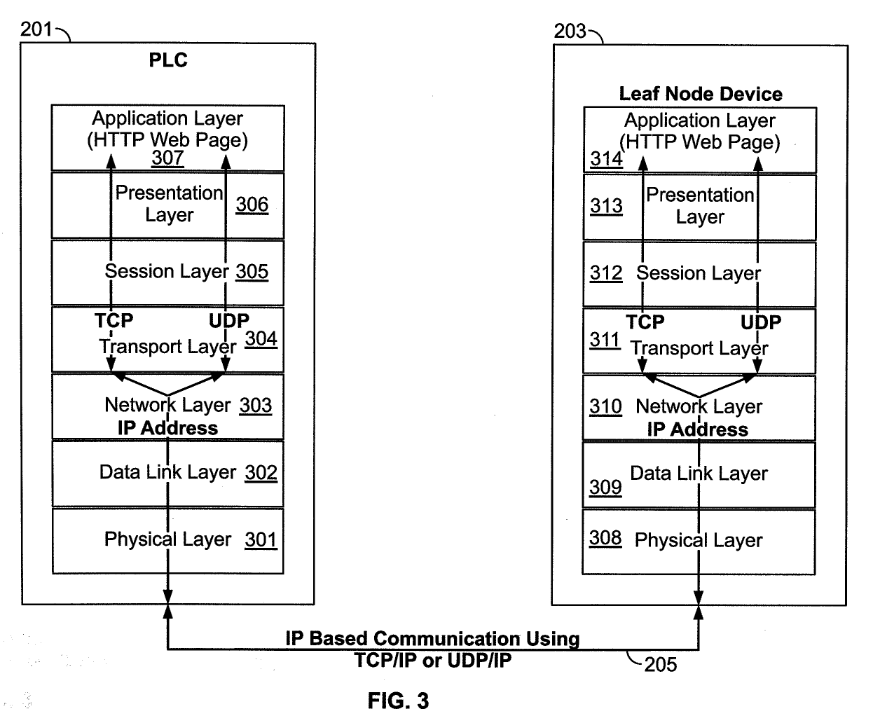

In an aspect of the invention, communication and control of low-level devices 204a-e by PLC 201 may be performed without an intermediary device. One or more low-level devices 204a-e may be located on leaf node device 203 as further discussed with FIG. 3. Leaf node device 203 includes a standalone apparatus that communicates with a programmable controller, includes a low-level I/O device, is uniquely identified by an IP address, and does not communicate directly with another leaf node device. Consequently, a leaf node device is the last destination for a message, in which the message is only meant for the low level I/O device. For example, if the low-level I/O device is a pilot-light, it will turn on or off based on the message. As another example, if the low-level I/O device is a temperature sensor, the temperature will be read back by the programmable controller.

Programmable controller 201 may directly control low-level devices 204a-e using Internet Protocol (IP). Signals (e.g., data packets) between programmable controller 201 and leaf node device 203 over automation bus 205 may use the same protocol that is native to programmable controller 201. In some embodiments of the invention, communication over automation bus 205 may be in accordance with Internet Protocol (IP), where IP is used throughout automation network 200. Leaf node device 203 may include IP capabilities so that programmable controller 201 may directly communicate with and control low-level devices 204a-e.

In an aspect of the invention, the architecture of industrial automation system 200 supports direct control of low-level devices 204a-e by programmable controller 201. With some embodiments, signals may comprise IP data packets that comply with Transmission Control Protocol (TCP) and/or User Datagram Protocol (UDP).

FIG. 3 shows protocol layering for IP-based communication between programmable controller 201 and leaf node device 203 in accordance with an embodiment of the invention. In an aspect of the invention, Internet Protocol packets are sent directly between programmable controller 201 and leaf node device 203 over automation bus 205. An IP packet is designated for leaf node device 203 based on the IP address that is contained in the IP packet and is assigned to leaf node device 203. The format of the IP packets may be IPv4 or IPv6. (IPv4 addressing is defined in IETF RFC 791, IETF RFC 1519 and IETF RFC 1918. IPv6 addressing is defined in IETF RFC 4291.) Embodiments of the invention may use different approaches for assigning IP addresses, including Bootstrap Protocol (BootP) and Dynamic Host Configuration Protocol (DHCP).

Communication between programmable controller 201 and leaf node device 203 may be modeled in accordance with the Open Systems Interconnection Reference Model (OSI Reference Model or OSI Model). The OSI Reference Model is an abstract description for layered communications and computer network protocol design. The OSI Reference Model divides network architecture into seven layers which, from top to bottom, are the application layer (corresponding to layers 307 and 314), presentation layer (corresponding to layers 306 and 313), session layer (corresponding to layers 305 and 312), transport layer (corresponding to layers 304 and 311), network layer (corresponding to layers 303 and 310), data link layer (corresponding to layers 302 and 309), and physical layer (corresponding to layers 301 and 308).

Embodiments of the invention support different protocols including Internet Protocol (corresponding to network layers 303 and 310), Transmission Control Protocol (TCP) and User Datagram Protocol (UDP) corresponds to transport layer 304 and 311.

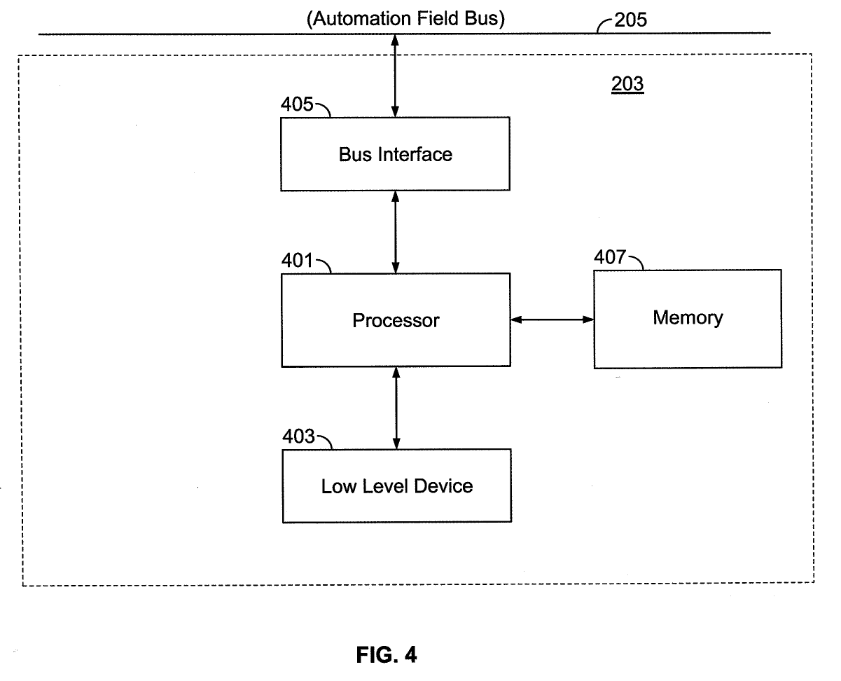

FIG. 4 shows leaf node device 203 in accordance with an embodiment of the invention. Leaf node device 203 interfaces with automation field bus 205 at the physical layer through bus interface 405. Bus interface 405 complies with electrical and physical specifications for the physical medium (e.g., pin layout, signal voltage levels, and cable specifications). For example, automation field bus 205 may transmit signal information (e.g., IP packet) by superimposing the signal information on a DC voltage. The DC voltage component may also provide electrical power for peripheral circuits (e.g., leaf node device 203). Bus interface 405 may convert the received signal information into an electrical form that may be processed by processor 401.

Processor 401 may process an IP packet and extracts control information from an IP data field when the IP packet from programmable controller 201 (as shown in FIG. 2) to leaf node device 203 includes control information for low-level device 403. Processor 401 processes the control information to control low-level device 403. For example, low-level device 403 may support two states (on/off), which corresponds to one bit of information in the IP data field. However, other embodiments may support low-level devices with more than two states, where additional bits of information are included in the IP data field.

In addition, leaf node device 203 may send an IP packet to programmable controller 201 in order to provide status information about low-level device 403, where status information is included in the IP data field. For example, processor 401 may determine the state of low-level device 403 and indicate the current state in the status information.

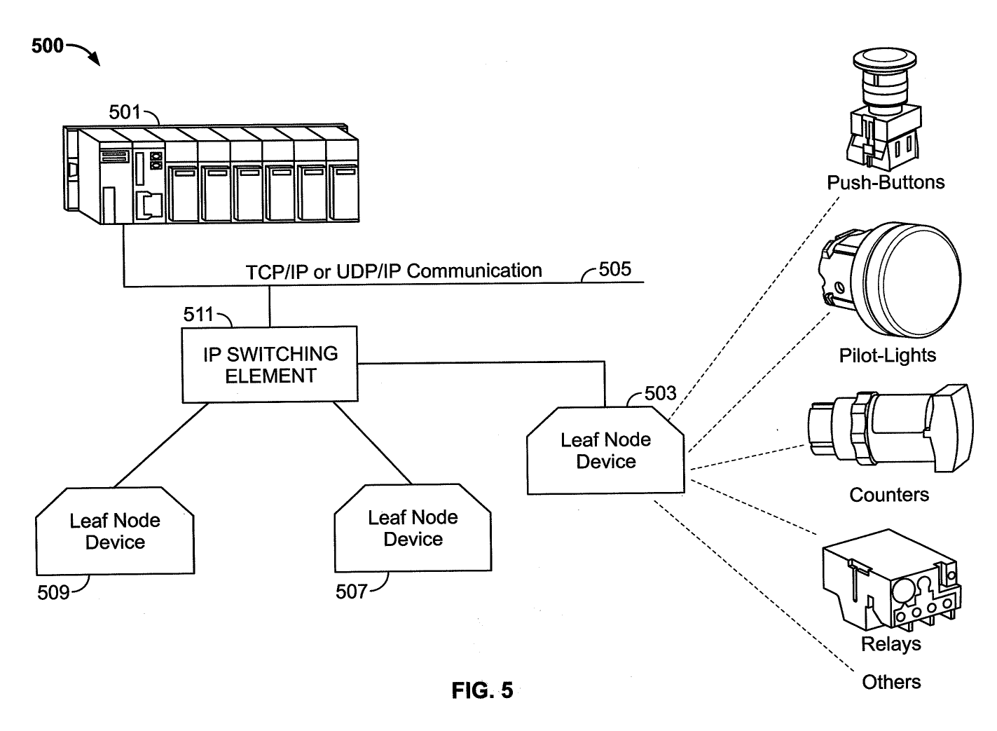

FIG. 5 shows industrial automation system 500 with IP switching element 511 in accordance with an embodiment of the invention. IP switching element may deliver IP packets over bus 505 to PLC 501 and leaf node devices 503, 507, and 509 based on the IP address in the packet. Each leaf node device has a unique IP address, where addressing may be limited by the Internet Protocol (e.g., IPv4 or IPv6). PLC 501, automation bus 505, and leaf node devices 503, 507, and 509 supports the communication medium (physical layer) in accordance with IP switching element 511. For example, IP switching element 511 may comprise a multiple port Ethernet switch or router or a gateway using standard Ethernet connectivity (port) on the programmable controller side and power line carrier port (DC wiring) on the low-level device side.

Because the Internet Protocol is used throughout automation system 500, translation from one language (not based on the Internet Protocol) to another language (based on the Internet Protocol) is circumvented.

With some embodiments, an Ethernet switch may be used rather than IP switching element 511, where Ethernet provides a communication medium (physical layer) for transporting IP packets between programmable controller 501 and leaf node devices 503, 507, and 509. Standard Ethernet switching and routing devices may be seamlessly introduced into automation network 500 to provide structure and traffic control. Low-level devices may be connected to the switching and routing devices with the proper cabling.

The Ethernet switch may deliver packets based on an Ethernet address (Media Access Control (MAC) address and corresponding to layer 2 of the OSI Reference Model). The Ethernet address may be obtained from the IP address using the Address Resolution Protocol (ARP) for Internet Protocol Version 4 (IPv4) or the Neighbor Discovery Protocol (NDP) for IPv6. The Ethernet switch may perform as a “proxy ARP” and respond to the network ARP when the Ethernet switch needs to know the IP addresses of the low-level devices. The Ethernet switch may extend the range of system 500 to allow for a larger number of devices to be controlled within the system. The communication from programmable controller 501 to leaf node devices 503, 507, and 509 may be seamless (transparent) to programmable controller 501 and leaf node devices 503, 507, and 509.

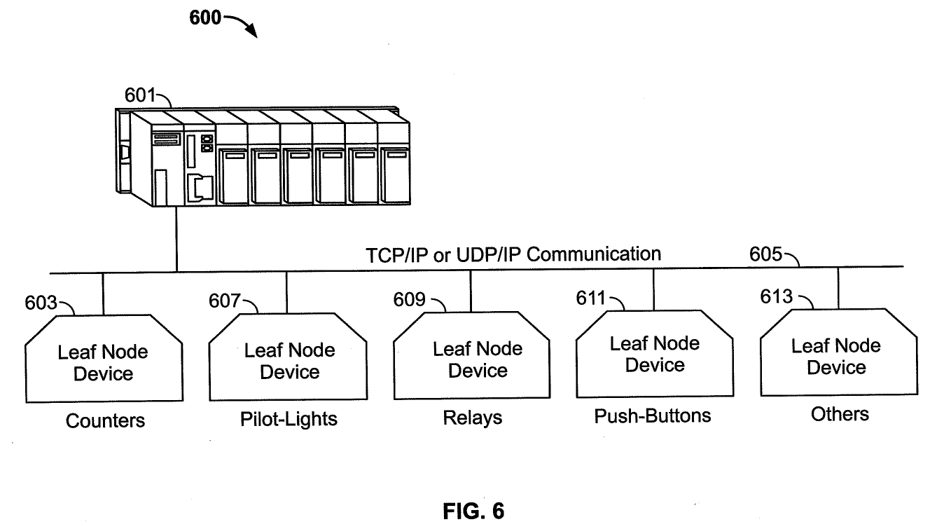

FIG. 6 shows an industrial automation system 600 without a switching element in accordance with an embodiment of the invention. In an embodiment, programmable controller 601 has direct control of leaf node devices 603, 607, 609, 611, and 613 over automation bus 605. Programmable controller 601 and leaf node devices 603, 607, 609, 611, and 613 may respond only to IP packets with the IP address assigned to the device.

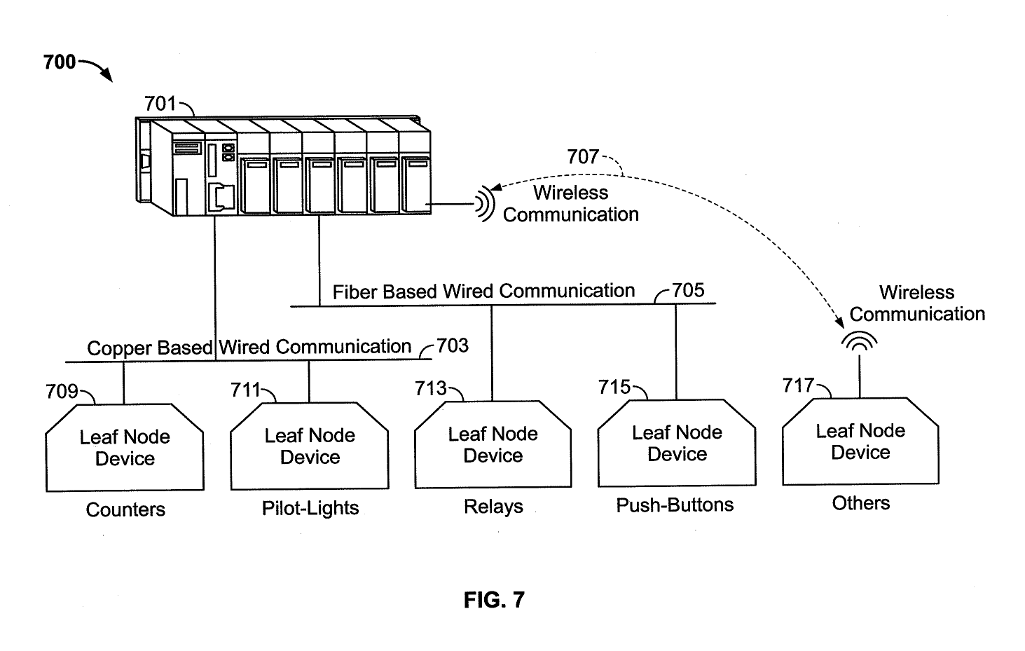

FIG. 7 shows industrial automation system 700 that supports different media when communicating between programmable controller 701 and leaf node devices 709, 711, 713, 715, and 717 in accordance with an embodiment of the invention. With some embodiments, the medium for the communication between PLC 701 and leaf node devices 709, 711, 713, 715, and 717 is media independent. Wired formats such as twisted pair copper, fiber, or wireless communication channels may be used. Further, system 700 may support a combination of different media. For example, programmable controller 701 communicates using Internet Protocol with leaf node devices 709 and 711, with low-level devices 713 and 715, and with low-level device 717 over copper-based media 703, fiber-based media 705, and wireless media 707, respectively.

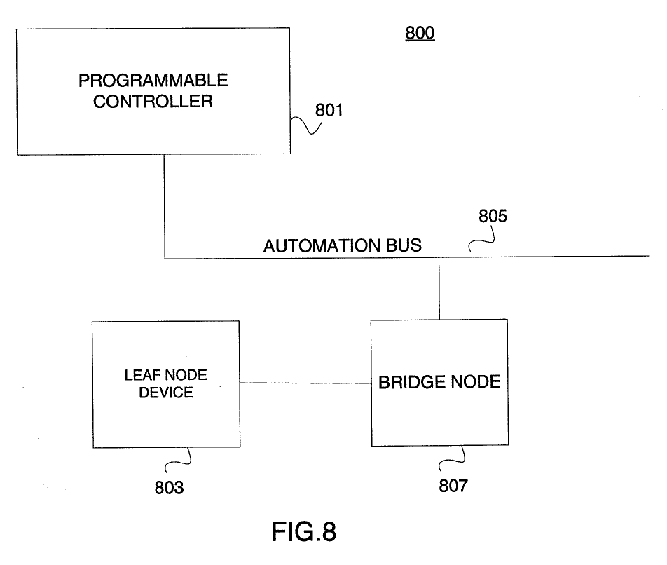

FIG. 8 shows industrial automation system 800 with a bridge node 807 in accordance with an embodiment of the invention. Bridge node 807 spans automation bus 805 during communications between leaf node device 803 and PLC 801. In an embodiment, bridge node 807 transforms a signal at a physical layer so that the signal is compatible with leaf node device 803. However, transparency at the network layer (e.g., Internet Protocol) may be maintained by bridge node 807. Migrating transformation at the physical layer from leaf node device 803 enables leaf node device 803 to be operable with different media that may be supported by automation bus 805.

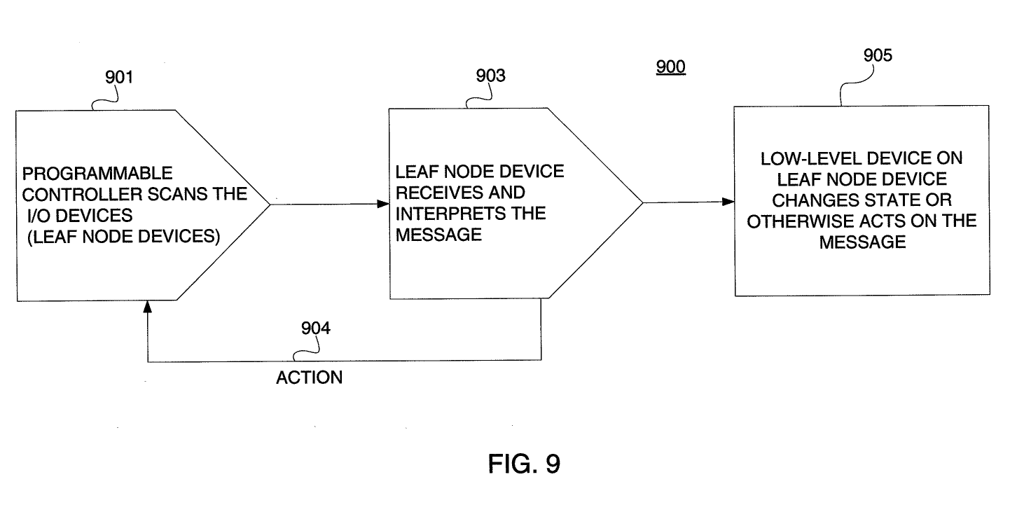

FIG. 9 shows process 900 that may be incorporated in an industrial automation system, in which a programmable controller controls a low-level device in accordance with an embodiment of the invention. In step 901, the programmable controller communicates directly to the low-level device using native IP based communication without protocol translation in step 901. The data path is assured to be correct as the IP Address for the associated leaf node device is unique so that only the desired low-level device will operate and respond to the specific message in step 903.

The desired operation from the programmable controller is performed by the low-level device in step 905. There is no confusion about the operation to be performed (read, write, change state, etc.) or about the low-level device to which the operation was targeted. The user's programming of the low-level device is typically simplified by removing memory location and bit confusion issues by the use of the IP address. The proper operation of the system is thus ascertained.

The leaf node device may confirm the message reception and/or that the desired operation was performed if the system is configured to do so by performing action 904 in order to complete a feedback loop. There is no confusion regarding which low-level device or which I/O function was completed. This approach provides a deterministic method of control confirmation.

Corruption of the data is reduced by the inherent error checking and correction built into the Internet Protocol. A single bit error or even several errors in the Internet Protocol packet typically does not affect the message sent to the low-level device as the bit error can be corrected by the features of the Internet Protocol. As the operation to be performed by the low-level device is part of the payload of the Internet Protocol packet and not a single bit in a series of bits that make up a word that controls several low-level devices, a mistake in the bit sequence may be avoided. Consequently, according to aspects of the invention as described above, corruption of any low-level device is avoided and operator mistakes are reduced in an industrial automation system.

As can be appreciated by one skilled in the art, a computer system with an associated computer-readable medium containing instructions for controlling the computer system may be utilized to implement the exemplary embodiments that are disclosed herein. The computer system may include at least one computer such as a microprocessor, digital signal processor, and associated peripheral electronic circuitry.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

I claim:

1. An industrial automation system comprising:
a programmable controller (PLC);
a first automation bus configured to receive a first signal for controlling a process on the industrial automation system and to transport the first signal that is compatible with Internet Protocol (IP); and
a first leaf node device that includes a first low-level device in direct communication with the PLC in accordance with the Internet Protocol over the first automation bus to control the first low-level device.

2. The industrial automation system of claim 1, wherein the first low-level device supports two states.

3. The industrial automation system of claim 1, further comprising:
a bridge node electrically connected between the PLC and the first leaf node device and configured to transform the first signal at a physical layer.

4. The industrial automation system of claim 1, further comprising:
a second leaf node device; and
an IP switch configured to receive the first signal and to direct the first signal to one of the leaf node devices based on an IP address contained in the first signal.

5. The industrial automation system of claim 1, further comprising:
a second automation bus configured to receive a second signal and to transport the second signal that is compatible with Internet Protocol (IP); and
a second leaf node device that includes a second low-level device in direct communication with the programmable controller in accordance with the Internet Protocol over the second automation bus to control the second low-level device.

6. The industrial automation system of claim 5, wherein the second automation bus comprises a different media than the first automation bus.

7. The industrial automation system of claim 1, further comprising:
a second leaf node device; and
an Ethernet switch configured to receive the first signal and to direct the first signal to one of the leaf node devices based on an Ethernet address contained in the first signal.

8. A leaf node device comprising:
a low-level device; and
a processor configured to:
communicate directly with a programmable controller in an industrial automation system over an automation bus in accordance with a communication protocol; and
process a data packet that is transported over the automation bus, wherein the data packet contains information for the low-level device.

9. The leaf node device of claim 8, wherein the processor is further configured to:
receive the data packet through the automation bus from the programmable controller;
extract control information from the data packet received over the automation bus; and
control the low-level device from the control information.

10. The leaf node device of claim 8, wherein the processor is further configured to:
obtain status information from the low-level device;
insert the status information in the data packet; and
transmit the data packet to the programmable controller.

11. The leaf node device of claim 8, wherein the communication protocol is compatible with Internet Protocol.

12. The leaf node device of claim 8, wherein the low-level device supports two states.

13. A computer-readable storage medium storing computer-executable instructions that, when executed, cause a processor to perform a method comprising:
communicating directly with a programmable controller in an industrial automation system over an automation bus in accordance with a communication protocol; and
processing a data packet that is transported over the automation bus, wherein the data packet contains information for the low-level device.

14. The computer-readable storage medium of claim 13, the method further comprising:
receiving the data packet through the automation bus from the programmable controller;
extracting control information from the data packet received over the automation bus; and
controlling the low-level device from the control information.

15. The computer-readable storage medium of claim 13, the method further comprising:
obtaining status information from the low-level device;
inserting the status information in the data packet; and
transmitting the data packet to the programmable controller.

16. The computer-readable storage medium of claim 13, wherein the low-level device supports two states.

17. A method for controlling an industrial automation system, the method comprising:
communicating directly with a programmable controller in an industrial automation system over an automation bus in accordance with a communication protocol;
and
processing a signal that is transported over the automation bus, wherein the signal contains information for the low-level device.

18. A method of claim 17, further comprising:
receiving the signal through the automation bus from the programmable controller;
extracting control information from the signal received over the automation bus;
and
controlling the low-level device from the control information.

19. A method of claim 17, further comprising:
obtaining status information from the low-level device;
inserting the status information in the signal; and
transmitting the signal to the programmable controller.

20. The method of claim 17, wherein the low-level device supports two states.

21. A method of claim 17, further comprising:
transforming the signal at a physical layer.

22. A method of claim 17, further comprising:
directing the signal to the low-level device based on an associated IP address.
